(19) United States
(12) Patent Application Publication
(10) Pub. No.: US 2009/0185127 A1
(43) Pub. Date: Jul. 23, 2009

(54) DISPLAY DEVICE

(75) Inventors: Shinya Tanaka, Mie (JP); Hajime Imai, Mie (JP); Chikanori Tsukamura, Mie (JP); Yoshiharu Kataoka, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/375,049

(22) PCT Filed: Jun. 21, 2007
(86) PCT No.: PCT/JP2007/062533

§ 371 Date: Jan. 26, 2009

(30) Foreign Application Priority Data
Jul. 27, 2006 (JP) 2006-205210

(51) Int. Cl. G02F 1/1345; G02F 1/1333

(52) U.S. Cl. 349/152; 349/160

(57) ABSTRACT

A display device includes a curved insulative substrate. A substrate line includes first input substrate lines electrically connected to first driving elements and first output substrate lines electrically connected to first lines and the first driving elements. The first output substrate lines are provided so as to be closer to the displaying region than are the first input substrate lines. Each first driving element has a rectangular shape with two longer sides and two shorter sides, the first driving element being mounted so that the longer sides are parallel or substantially parallel to the direction in which the first lines extend.

### BACKGROUND OF THE INVENTION

1. Field of the Invention

The present invention relates to a display device, and more particularly to a display device having a curved shape.

2. Description of the Related Art

Generic display devices have substantially planar or rectangular solid shapes. However, in a display device having such a shape, external light in the surroundings may be reflected by an insulative substrate (e.g., a glass substrate), so that the surrounding landscapes may appear as reflection glares overlaid on a video on the display device, possibly causing a misperception of the video. Therefore, adopting a curved shape for the display device is known to suppress reflection glares. In a display device of a curved shape, the insulative substrate is curved in a predetermined shape (see, for example, Japanese Laid-Open Patent Publication No. 11-38395).

Generally speaking, an active matrix substrate that is used for a display device such as a liquid crystal display device includes a plurality of driving elements (semiconductor chips) which are mounted in a terminal region of an insulative substrate. The driving elements generate data signals and gate signals based on input signals, and supply these signals to signal lines and scanning lines.

### SUMMARY OF THE INVENTION

The inventors of the invention described in the present application have discovered that, when driving elements are simply mounted on a curved insulative substrate, the driving elements may become detached from the insulative substrate due to a load which emanates from bending stress. On the other hand, if the manner of mounting the driving elements is changed in order to suppress detachment of the driving elements from the insulative substrate, the design of substrate lines which are electrically connected to the driving elements will become complicated, so that a broad region will be required for forming the substrate lines. Consequently, enlargement of the insulative substrate size may become necessary.

Preferred embodiments of the present invention have been developed in view of the above problems, and provide a display device in which detachment of driving elements from a curved insulative substrate is prevented, and in which an increase in size of the insulative substrate is minimized and prevented.

A display device according to a preferred embodiment of the present invention is a display device including an active matrix substrate and a display medium layer disposed on a principal surface of the active matrix substrate, wherein, the active matrix substrate includes: an insulative substrate having a principal surface which includes a displaying region and a terminal region, a plurality of circuit elements provided in the displaying region of the insulative substrate, a plurality of first lines and a plurality of second lines connected to the plurality of circuit elements, a plurality of substrate lines provided in the terminal region of the insulative substrate, at least one first driving element mounted in the terminal region of the insulative substrate to supply a signal to the plurality of first lines, and at least one second driving element mounted in the terminal region of the insulative substrate to supply a signal to the plurality of second lines; the insulative substrate is curved; the plurality of substrate lines include a plurality of first input substrate lines which are electrically connected to the at least one first driving element and a plurality of first output substrate lines which are electrically connected to the plurality of first lines and the at least one first driving element, the first output substrate lines corresponding to the at least one first driving element being disposed so as to be closer to the displaying region than are the first input substrate lines; and when the at least one first driving element is viewed from a normal direction of the principal surface of the insulative substrate, the at least one first driving element has a rectangular or substantially rectangular shape with two longer sides and two shorter sides, the at least one first driving element being mounted so that each longer side thereof is parallel or substantially parallel to a direction in which the first lines extend.

In one preferred embodiment of the present invention, input bumps electrically connected to the first input substrate lines and output bumps electrically connected to the first output substrate lines are provided on the at least one first driving element.

In one preferred embodiment of the present invention, when the at least one second driving element is viewed from the normal direction of the principal surface of the insulative substrate, the at least one second driving element has a rectangular or substantially rectangular shape with two longer sides and two shorter sides, the longer sides of the at least one second driving element being disposed parallel or substantially parallel to the longer sides of the at least one first driving element.

In one preferred embodiment of the present invention, the insulative substrate is curved in a direction which is perpendicular or substantially perpendicular to each longer side of the at least one first driving element.

In one preferred embodiment of the present invention, the principal surface of the insulative substrate is curved in a concave shape.

In one preferred embodiment of the present invention, the principal surface of the insulative substrate is curved in a convex shape.

In one preferred embodiment of the present invention, each first line is one of a signal line and a scanning line, and each second line is the other of a signal line and a scanning line.

In one preferred embodiment of the present invention, the insulative substrate is a glass substrate.

In one preferred embodiment of the present invention, the insulative substrate is a plastic substrate.

In one preferred embodiment of the present invention, the at least one first driving element and the at least one second driving element are each mounted via an anisotropic electrically-conductive layer.

In one preferred embodiment of the present invention, the display device further includes a counter substrate opposing the active matrix substrate via the display medium layer, wherein, the display medium layer is a liquid crystal layer.

In one preferred embodiment of the present invention, the display device further includes a circuit arranged to receive a television broadcast.

In an automotive vehicle according to a preferred embodiment of the present invention, the display device according to one of the above-described preferred embodiments is preferably used as an instrument panel.

According to various preferred embodiments of the present invention, there is provided a display device in which detachment of driving elements from a curved insulative substrate is prevented, and in which an increase in size of the insulative substrate is reduced.

Other features, elements, steps, characteristics and advantages of the present invention will become more apparent from the following detailed description of preferred embodiments of the present invention with reference to the attached drawings.

### BRIEF DESCRIPTION OF DRAWINGS

FIG. 1A is a schematic cross-sectional view of a preferred embodiment of a display device according to the present invention, FIG. 1B is a schematic side view of the display device of the present preferred embodiment, and FIG. 1C is a schematic plan view of the display device of the present preferred embodiment.

FIG. 2 is a schematic diagram of signal line driving elements in the display device of the present preferred embodiment.

FIG. 3 is a schematic plan view of a display device of a first comparative example.

FIG. 4 is a schematic plan view of a display device of a second comparative example.

FIG. 5 is a schematic diagram of a signal line driving element of the display device the second comparative example.

FIG. 6 is a diagram showing an example where the display device of Preferred Embodiment 2 is used for an instrument panel.

FIG. 7 is a schematic plan view showing a variant of the display device of the present preferred embodiment.

FIG. 8 is a schematic plan view showing another variant of the display device of the present preferred embodiment.

FIG. 9A is a schematic side view of a variant of the display device of the present preferred embodiment, and FIG. 9B is a schematic plan view of the display device shown in FIG. 9A.

### DETAILED DESCRIPTION OF THE PREFERRED EMBODIMENTS

Hereinafter, preferred embodiments of a display device according to the present invention will be described with reference to the drawings. Herein, a liquid crystal display device will be illustrated as an example of a display device.

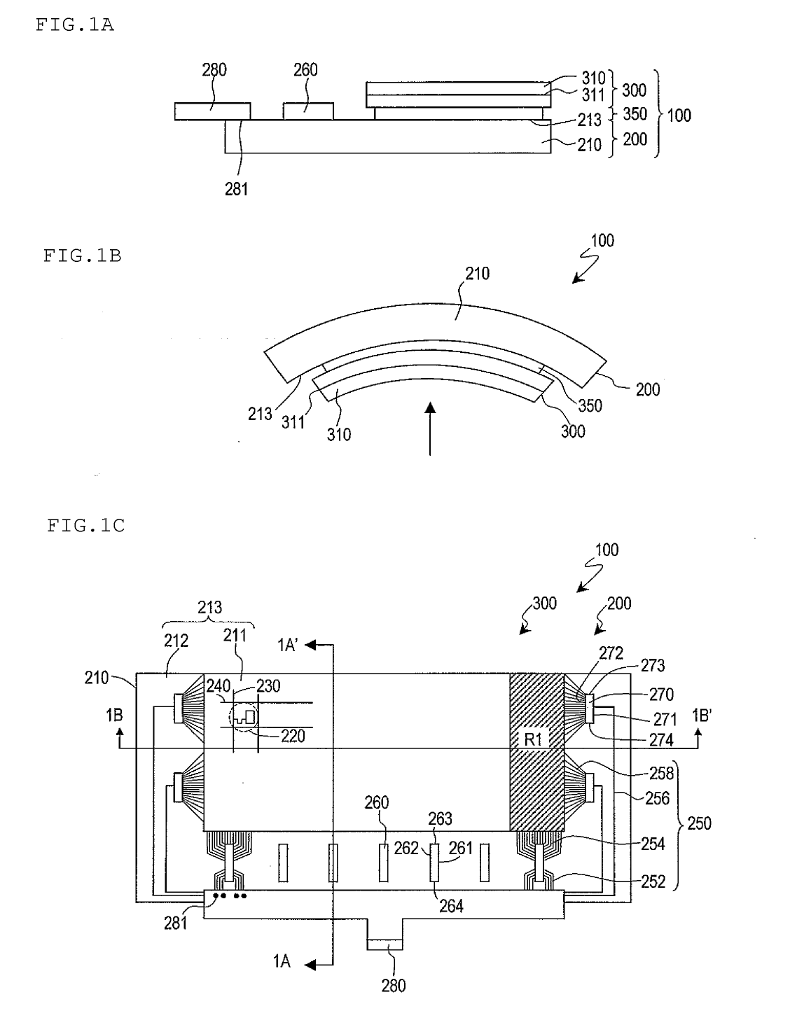

As shown in FIG. 1A, the display device 100 of the present preferred embodiment includes an active matrix substrate 200, a counter substrate 300, and a display medium layer 350 interposed between the active matrix substrate 200 and the counter substrate 300. As shown in FIG. 1B, the display device 100 of the present preferred embodiment has a curved shape. Herein, the display device 100 is a liquid crystal display device, and the display medium layer 350 is a liquid crystal layer. In this case, an image is displayed when each pixel modulates the light which is emitted from a backlight (not shown).

FIG. 1C shows a schematic construction when the display device 100 is viewed from the normal direction of the display surface. The active matrix substrate 200 preferably includes: an insulative substrate 210 having a principal surface 213 which includes a displaying region 211 and a terminal region 212; a plurality of circuit elements 220 provided in the displaying region 211 of the insulative substrate 210; a plurality of lines 230 and a plurality of lines 240 connected to the plurality of circuit elements 220; a plurality of substrate lines 250 provided in the terminal region 212 of the insulative substrate 210; a plurality of driving elements 260 arranged to supply signals to the plurality of lines 230; and driving elements 270 arranged to supply signals to the plurality of lines 240. The driving elements 260 and 270 preferably are bare chips, for example, and are mounted in the terminal region 212 of the insulative substrate 210. Moreover, an input substrate 280 is attached in the terminal region 212 of the insulative substrate 210.

Note that, in the following descriptions of the present specification, the lines 230 and 240 will be referred to as first lines and second lines, respectively; the driving elements 260 will be referred to as first driving elements; and the driving elements 270 will be referred to as second driving elements. Herein, the first lines 230 are signal lines; the second lines 240 are scanning lines; the first driving elements 260 are signal line driving elements; and the second driving elements 270 are scanning line driving elements. Moreover, the signals which are supplied by the signal line driving elements 260 to the signal lines 230 are data signals, whereas the signals which are supplied by the scanning line driving elements 270 to the scanning lines 240 are gate signals.

FIG. 1A corresponds to a cross section along line 1A-1A′ in FIG. 1C. As shown in FIG. 1A, the counter substrate 300 includes an insulative substrate 310. The area of the principal surface 213 of the insulative substrate 210 is greater than that of the principal surface 311 of the insulative substrate 310, and the insulative substrate 310 is disposed so as to overlap the insulative substrate 210. Note that, in the following descriptions of the present specification, the insulative substrate 210 of the active matrix substrate 200 may be referred to as a “first insulative substrate”, whereas the insulative substrate 310 of the counter substrate 300 may be referred to as a “second insulative substrate”. Herein, the first and second insulative substrates 210 and 310 are glass substrates. For example, the first insulative substrate 210 preferably has an outer size of approximately 383.8 mm×122 mm; the second insulative substrate 310 has an outer size of approximately 373.8 mm×116.5 mm; and the first and second insulative substrates 210 and 310 have a thickness of about 0.25 mm, for example.

FIG. 1B corresponds to a cross section along line 1B-1B′ in FIG. 1C. The arrow shown in FIG. 1B indicates a direction in which a viewer of the display device 100 watches the display surface. The first insulative substrate 210 and the second insulative substrate 310 are curved with respect to a bending axis which is parallel or substantially parallel to the signal lines 230, in a direction that the scanning lines 240 extend, i.e., the lateral direction. As shown in FIG. 1B, the principal surface 213 of the first insulative substrate 210 is curved in a concave shape, whereas the principal surface 311 of the second insulative substrate 310 is curved in a convex shape, such that the principal surface 311 of the second insulative substrate 310 is parallel to the principal surface 213 of the first insulative substrate 210. Radii of curvature of the first and second insulative substrates 210 and 310 preferably are about 600 R to about 1500 R (about 600 mm to about 1500 mm), for example; herein, radii of curvature of the first and second insulative substrates 210 and 310 are preferably about 1000 R.

In the displaying region 211, the signal lines 230 and the scanning lines 240 are disposed so that they cross each other perpendicularly. FIG. 1C shows two signal lines 230 and two scanning lines 240 as an exemplification. Each circuit element 220 has a pixel electrode and a thin film transistor. Moreover, the signal line driving elements 260 and the scanning line driving elements 270 are mounted on the insulative substrate 210 via an anisotropic electrically-conductive layer (not shown). The anisotropic electrically-conductive layer is preferably formed by using an anisotropic electrically-conductive film (ACF), anisotropic electrically-conductive paste (ACP), or the like.

The plurality of substrate lines 250 include: input substrate lines 252, which are electrically connected to terminals 281 of the input substrate 280 and the signal line driving elements 260; output substrate lines 254, which are electrically connected to the signal lines 230 and the signal line driving elements 260; input substrate lines 256, which are electrically connected to the terminals 281 of the input substrate 280 and the scanning line driving elements 270; and output substrate lines 258, which are electrically connected to the scanning lines 240 and the scanning line driving elements 270. In the following descriptions of the present specification, the input substrate lines 252 will be referred to as first input substrate lines; the output substrate lines 254 will be referred to as first output substrate lines; the input substrate lines 256 will be referred to as second input substrate lines; and the output substrate lines 258 will be referred to as second output substrate lines. Note that adjoining substrate lines 250 are disposed apart by a predetermined distance (e.g., about 31 μm), so as to electrically insulated from each other.

Note that, although the first input substrate lines 252 and the first output substrate lines 254 are provided for each signal line driving element 260, FIG. 1C only shows those corresponding to the signal line driving elements 260 that are provided at both ends of a row of signal line driving elements 260, in order to prevent the figure from becoming too complicated. Similarly, although the terminals 281 of the input substrate 280 are provided so as to be electrically connected to the respective first input substrate lines for each signal line driving element 260, FIG. 1C only shows those corresponding to the signal line driving element 260 at the left end, in order to prevent the figure from becoming too complicated.

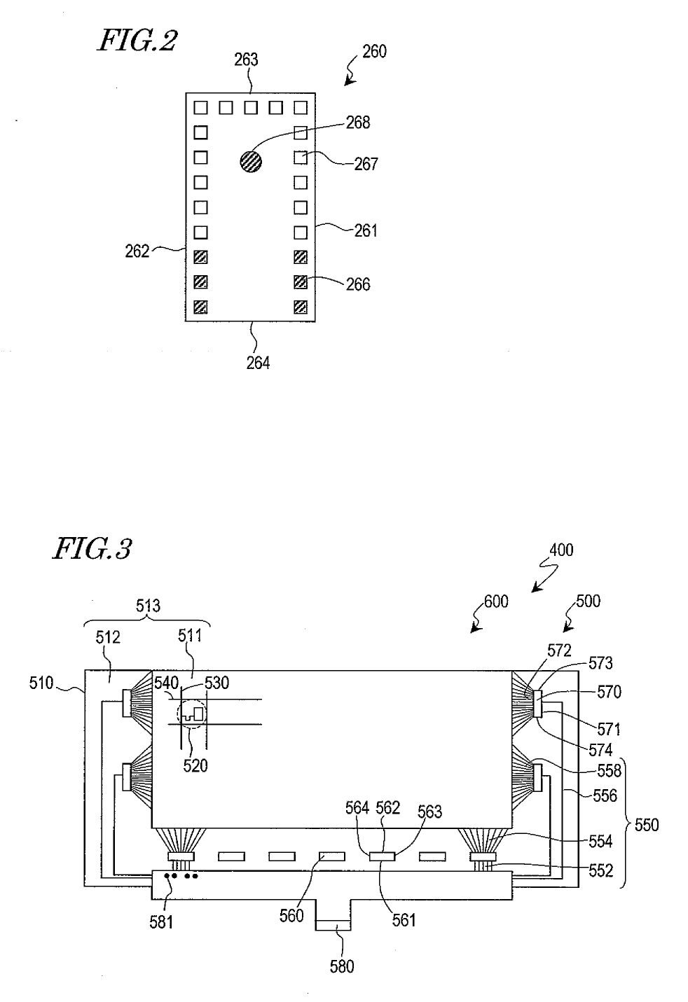

Hereinafter, the construction of the signal line driving elements 260 will be described. FIG. 2 shows a signal line driving element 260 as viewed from the normal direction of the principal surface 213 of the first insulative substrate 210. The signal line driving element 260 has a rectangular or substantially rectangular shape having two longer sides 261, 262 and two shorter sides 263, 264, such that the ratio between the shorter sides 263, 264 and the longer sides 261, 262 is approximately 1:10, for example. Note that the scanning line driving elements 270 also have a similar construction to that of the signal line driving elements 260, such that, when viewed from the normal direction of the principal surface 213 of the first insulative substrate 210, each scanning line driving element 270 has a rectangular or a substantially rectangular shape having two longer sides 271, 272 and two shorter sides 273, 274. Moreover, the ratio between the shorter sides 273, 274 and the longer sides 271, 272 is substantially similar to that of the signal line driving elements 260. Note that, in a strict manner, the ratio of the shorter sides and the longer sides may be different between the signal line driving elements 260 and the scanning line driving elements 270.

Input bumps 266 and output bumps 267 shown in FIG. 2 are provided on a surface of the signal line driving element 260 that opposes the principal surface 213 of the first insulative substrate 210 (see FIG. 1A and FIG. 1C), and an integrated circuit 268 shown in FIG. 2 is incorporated inside the signal line driving element 260. Note that, as will be understood from FIG. 1C and FIG. 2, the input bumps 266 are disposed on the input substrate side so as to be connected to the first input substrate lines 252 of the first insulative substrate 210, whereas the output bumps 267 are disposed on the displaying region side so as to be connected to the first output substrate lines 254 of the first insulative substrate 210. In the signal line driving element 260, the number of output bumps 267 is greater than the number of input bumps 266. While FIG. 2 schematically shows the input bumps 266 and output bumps 267 provided on the signal line driving element 260, there may be 42 input bumps 266 and 480 output bumps 267, for example. Moreover, the interval between adjoining output bumps 267 preferably is about 36 μm, for example.

FIG. 1C is referred to again. Input signals are input from the terminals 281 of the input substrate 280 to the signal line driving elements 260 and the scanning line driving elements 270, respectively, via the first input substrate lines 252 and the second input substrate lines 256 provided in the terminal region 212 of the first insulative substrate 210. An integrated circuit (see FIG. 2; not shown in FIG. 1C) is incorporated in each of the signal line driving elements 260 and the scanning line driving elements 270. Each integrated circuit performs a predetermined process based on an input signal to generate a data signal and a gate signal, and they supply the data signals and the gate signals to the signal lines 230 and the scanning lines 240 respectively via the first output substrate lines 254 and the second output substrate lines 258. FIG. 1C shows a region R1 that accommodates signal lines 230 to which a data signal is supplied from a single signal line driving element 260. As shown in FIG. 1C, the signal line driving element 260 is disposed near the center of a shorter side of the region R1.

Hereinafter, the construction of the display device 100 of the present preferred embodiment will be described in comparison with that of the display device 400 of a first comparative example. First, referring to FIG. 3, the construction of the display device 400 of the first comparative example will be described.

A first insulative substrate 510 and a second insulative substrate are curved also in the display device 400 of the first comparative example, as in the display device 100 of the present preferred embodiment. However, the display device 400 of the first comparative example differs from the display device 100 of the present preferred embodiment in that longer sides 561, 562 of each signal line driving element 560 are parallel to scanning lines 540. In the following descriptions of the present specification, when a signal line driving element 560 is disposed so that the longer sides 561, 562 of the signal line driving element 560 are parallel to the scanning lines 540, as in the display device 400 of the first comparative example, the signal line driving element may be referred to as being laterally positioned. On the other hand, as in the display device 100 of the present preferred embodiment, when a signal line driving element 260 is disposed so that the longer sides 261, 262 of the signal line driving element 260 are perpendicular or substantially perpendicular to the scanning lines 240 (i.e., parallel to the signal lines 230), the signal line driving element may be referred to as being vertically positioned.

In the display device 400 of the first comparative example, the signal line driving elements 560 are laterally positioned on the first insulative substrate 510 which is curved in the lateral direction. Therefore, due to a bending stress, a load acts along the longer sides 561, 562 of the signal line driving elements 560 so as to detach it from the first insulative substrate 510. In particular, a strong load acts on those signal line driving elements 560 which are at both ends of the row of signal line driving elements 560. If the signal line driving elements 560 are detached from a principal surface 513 of the first insulative substrate 510, the connections between the signal line driving elements 560 and input substrate lines 552 and output substrate lines 554 will become insufficient.

On the other hand, in the display device 100 of the present preferred embodiment, as shown in FIG. 1B and FIG. 1C, the signal line driving elements 260 are vertically positioned on the first insulative substrate 210 which is curved in the lateral direction. In this case, even if the first insulative substrate 210 is curved, the signal line driving elements 260 are unlikely to be detached from the first insulative substrate 210, and the electrical connection of the signal line driving elements 260 is ensured.

Thus, in the display device 100 of the present preferred embodiment, since the signal line driving elements 260 are vertically positioned, the electrical connection of the signal line driving elements 260 is ensured even if the first insulative substrate 210 is curved in the lateral direction. Moreover, in the display device 100 of the present preferred embodiment, the longer sides 271, 272 of the scanning line driving elements 270 are also disposed parallel or substantially parallel to the longer sides 261, 262 of the signal line driving elements 260, and thus the electrical connection of the scanning line driving elements 270 is ensured for a reason similar to that for the signal line driving elements 260.

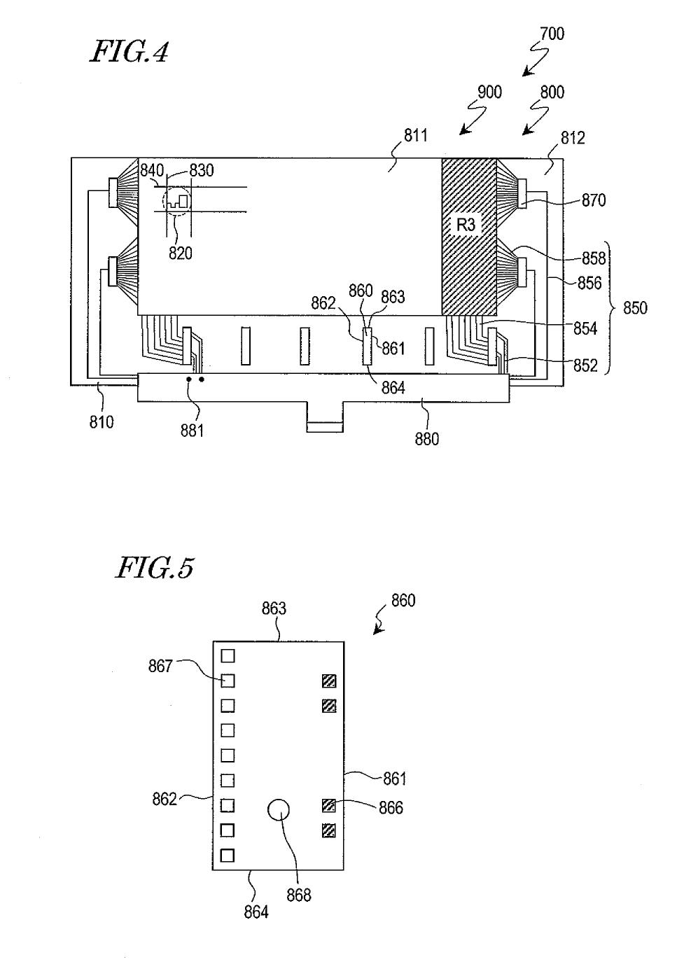

Next, the construction of the display device 100 of the present preferred embodiment will be described in comparison with the display device 700 of the second comparative example. First, with reference to FIG. 4 and FIG. 5, the construction of the display device 700 of the second comparative example will be described. As shown in FIG. 4, in the display device 700 of the second comparative example, signal line driving elements 860 are vertically positioned in a manner similar to the display device 100 of the present preferred embodiment. However, the display device 700 of the second comparative example differs from the display device 100 of the present preferred embodiment in that, as the signal line driving elements 860, those which are similar to what is commonly used in the case where the signal line driving elements are laterally positioned are used.

FIG. 5 shows the construction of a signal line driving element 860 in the display device 700 of the second comparative example. Similarly to what is commonly used in the case where the signal line driving elements are laterally positioned, the signal line driving element 860 has input bumps 866 along one longer side 861 and output bumps 867 along the other longer side 862.

As shown in FIG. 4, the signal line driving elements 860 are vertically positioned in the display device 700 of the second comparative example, and substrate lines 850 are provided on a first insulative substrate 810 so as to conform to the signal line driving elements 860. Specifically, input substrate lines 852 are provided so as to extend from terminals 881 of the input substrate 880 toward the longer side 861 of each signal line driving element 860, whereas output substrate lines 854 are provided so as to extend from the longer side 862 of each signal line driving elements 860 toward signal lines 830. Since the input substrate lines 852 and the output substrate lines 854 are provided in this manner in the display device 700 of the second comparative example, those input substrate lines 852 which are provided closer to the displaying region along the longer side 861 of each signal line driving element 860 and those output substrate lines 854 which are provided closer to the input substrate along the longer side 862 of each signal line driving element 860 become long. Thus, positioning of the input substrate lines 852 and the output substrate lines 854 requires a complicated designing, which requires a broad region for forming the output substrate lines 854, thus resulting in an enlarged size of the insulative substrate 810. On the other hand, in the display device 100 of the present preferred embodiment, as shown in FIG. 1C, the first input substrate lines 252 are provided on the input substrate side, and the first output substrate lines 254 are provided on the displaying region side, whereby the first input substrate lines 252 and the first output substrate lines 254 become short. As a result, it is easy to design the positioning of the first input substrate lines 252 and the first output substrate lines 254, thus making it possible to form the first output substrate lines 254 in a narrow region, whereby an increase in size of the first insulative substrate 210 is reduced.

To be more specific, in the display device 700 of the second comparative example, the plurality of input substrate lines 852 and output substrate lines 854 both have parallel portions which extend parallel or substantially to the longer sides 861, 862 of the signal line driving elements 860. Looking at these parallel portions, the parallel portions are arranged so as to flank one by one along the lateral width of the insulative substrate 810, so that the input substrate lines 852 and output substrate lines 854 to be connected to one signal line driving element 860 cannot be formed within a narrow region. On the other hand, in the display device 100 of the present preferred embodiment, although the first input substrate lines 252 and second output substrate lines 254 both have parallel portions which extend parallel or substantially parallel to the longer sides 261, 262 of the signal line driving elements 260, the parallel portions of the first input substrate lines 252 are disposed closer to the input substrate than are the parallel portions of the second output substrate lines 254, in a coinciding arrangement with them with respect to the lateral width of the first insulative substrate 210. As a result, the input substrate lines 252 and output substrate lines 254 to be connected to one signal line driving elements 260 can be formed within a narrow region.

Moreover, in the display device 700 of the second comparative example, as shown in FIG. 4, each signal line driving element 860 is disposed at an edge of a shorter side of a region R3 where the signal lines 830 to which a data signal is supplied by this signal line driving element 860 are provided. In this case, the output substrate lines 854 reaching the respective signal lines 830 from the signal line driving element 860 become long, thus resulting in signal delays. Moreover, since there are large differences in length among the output substrate lines 854 reaching the respective signal lines 830 from the signal line driving element 860, deterioration in display quality may occur due to signal delays. On the other hand, in the display device 100 of the present preferred embodiment, the first output substrate lines 254 reaching the respective signal lines 230 from the signal line driving element 260 can be shortened, thus suppressing signal delays. Moreover, as shown in FIG. 1C, in the display device 100 of the present preferred embodiment, each signal line driving element 260 is disposed near the center of a shorter side of the region R1, such that the first input substrate lines 252 and the first output substrate lines 254 are disposed axisymmetrically with respect to the signal line driving element 260. As a result, the differences in length among the first output substrate lines 254 reaching the respective signal lines 230 from the signal line driving element 260 can be reduced, thus suppressing the deterioration in display quality.

Thus, in accordance with the display device 100 of the present preferred embodiment, it is easier to design the positioning of the substrate lines 250, and it is possible to form the first output substrate lines 252 within a narrow region.

Moreover, since the display device 100 of the present preferred embodiment has a curved shape, it is possible to support reflection glare as mentioned above. Moreover, the display device 100 of the present preferred embodiment has the following advantages in addition to suppression of reflection glare.

Since the display device has a curved shape, the display device has an improved design freedom, thus further broadening the range of applications for the display device. For example, the display device 100 is suitably used as a display device for an instrument panel to be incorporated in an automotive vehicle. As used herein, an “automotive vehicle” broadly refers to any vehicle or machine which is capable of self propulsion and used for passenger or article transportation or moving of objects, without being limited to so-called automobiles. When a display device is used in an automotive vehicle, generally speaking, there is a tendency that the driving elements are likely to be detached from the insulative substrate due to vibrations and the like. However, in the display device 100 of the present preferred embodiment, the signal lines and the scanning line driving elements 260, 270 are disposed in a manner not likely to be detached from the first insulative substrate 210, so that the display device 100 is suitably used for automotive vehicles.

Specifically, an instrument panel of an automobile may carry various instruments such as a speedometer. In the place of such instruments, a display device having a curved shape can be used. In recent years, there is a tendency that automobiles having a curved structure are preferred. By using a curved liquid crystal display device as an instrument panel, it becomes possible to produce an automobile which satisfies the preferences of users.

FIG. 6 shows an example where the display device 100 of the present preferred embodiment is used for an instrument panel of a four-wheeled automobile. FIG. 6 shows an example where the velocity, shift lever position, remaining battery power, water temperature, and remaining fuel amount of the automotive vehicle are displayed on the right-hand side of a displaying region 211, whereas car navigation information is displayed on the left-hand side of the displaying region 211. The car navigation information is information of a current location or a route to a destination for a driver during travel.

In addition to improvements in design freedom, since the display device 100 has a curved shape, differences in distances from the viewer to the central portion and peripheral portions on the display surface can be reduced, whereby an enhanced display realism is provided.

A curved insulative substrate can be produced by known methods as described below. For example, an insulative substrate may be sandwiched by acrylic plates having a curved-surface shape, and a pressure may be applied so as to compress the two acrylic substrates, whereby a curved insulative substrate can be produced. Alternatively, an insulative substrate may be secured to an acrylic plate having a curved-surface shape, whereby a curved insulative substrate can be produced.

Alternatively, the insulative substrate may be curved by press forming. Specifically, after overlaying a second insulative substrate on a first insulative substrate, at a high temperature, they may be pressed with a concave shaping die and a convex shaping die having a predetermined radius of curvature, thus performing a press forming. Alternatively, after overlaying a second insulative substrate on a first insulative substrate, a self-weight forming may be performed at a high temperature, followed by a press forming.

Alternatively, the insulative substrate may be curved by holding a flexible insulative substrate in a curved manner. Specifically, a retention member having a curved surface may be kept in close contact with an insulative substrate, thus holding the insulative substrate in a curved manner. Alternatively, a slit in the form of a curved surface which is curved in a convex manner may be formed so as to penetrate a retention member of a rectangular solid shape, and an insulative substrate may be inserted into the slit so as to allow the insulative substrate to be curved.

Moreover, the display device may have a mechanism for curving the insulative substrate in a variable manner. Specifically, coupling members for holding the display device so as to be capable of pivoting may be provided at both sides along the longitudinal direction of the display device; these coupling members may be attached to nuts which move along a screw shaft; and by rotating the screw shaft with a motor, the curved shape may be changed in a variable manner.

Alternatively, two insulative substrates with respectively different coefficients of thermal expansion may be used, and the respective insulative substrates may be allowed to be curved. Specifically, when substrates whose coefficients of thermal expansion differ in at least one direction are allowed to adhere at a temperature which is higher than the temperature of use, a bending stress occurs in the two insulative substrates at room temperature, whereby the substrates may be allowed to be curved.

Note that the first insulative substrate 210 may be curved after mounting the signal line driving elements 260 and scanning line driving elements 270 on the first insulative substrate 210 having a planar shape, or, the signal line driving elements 260 and scanning line driving elements 270 may be mounted after curving the first insulative substrate 210. However, mounting can be performed more easily by curving the first insulative substrate 210 after mounting the signal line driving elements 260 and scanning line driving elements 270. Thus, a curved insulative substrate can be produced by various methods.

In the above description, an instrument panel of an automotive vehicle is preferably illustrated as an example of application of a display device having a curved shape; however, the present invention is not limited thereto. For example, a circuit for receiving a television broadcast may be provided for a display device having a curved shape, and this display device may be utilized in a large-size television set. In this case, too, the viewer will feel surrounded by the concave-shaped display surface, thus being able to view a realistic video.

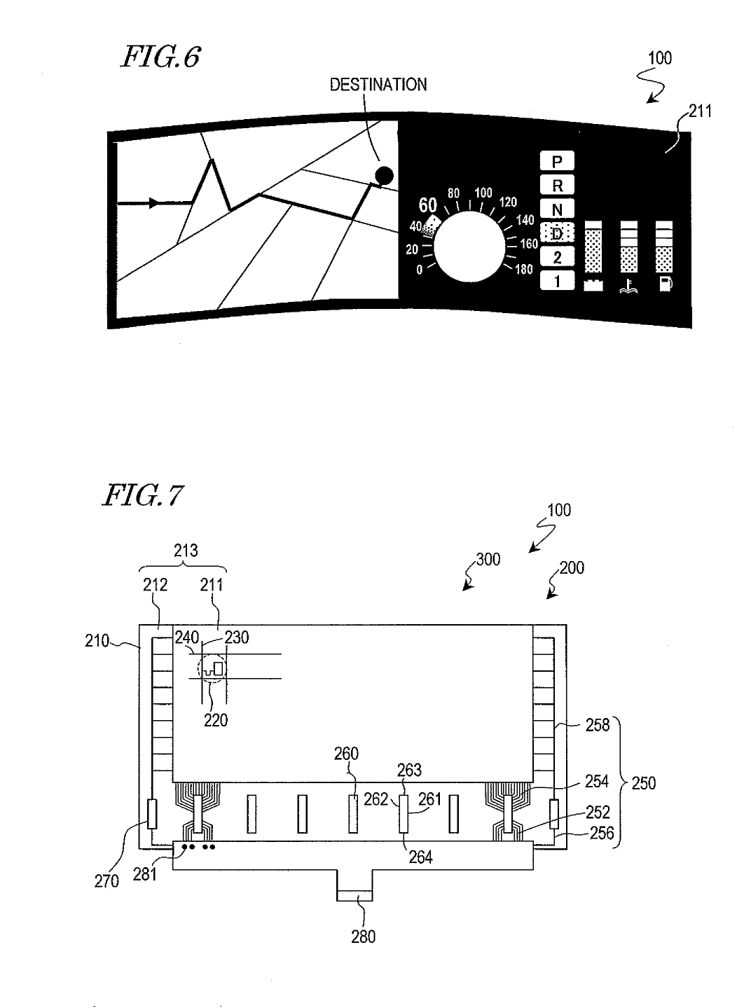

In the display device 100 shown in FIG. 1C, the longer side 272 of each scanning line driving element 270 preferably opposes the displaying region 211; however, the present invention is not limited thereto. As shown in FIG. 7, the scanning line driving elements 270 may be disposed in the same row as the signal line driving elements 260. As a result, the lateral width of the first insulative substrate 210, i.e., the lateral width of the active matrix substrate 200 can be reduced.

In the above description, the signal line driving elements 260 and the scanning line driving elements 270 preferably are mounted on the first insulative substrate 210 via an anisotropic electrically-conductive layer; however, the present invention is not limited thereto. The signal line driving elements 260 and the scanning line driving elements 270 may be mounted via solder.

In the above description, the first and second insulative substrates 210 and 310 preferably are glass substrates; however, the present invention is not limited thereto. As the first and second insulative substrates 210 and 310, transparent substrates other than glass substrates (e.g., plastic film substrates or resin substrates) may be used. Specifically, the first and second insulative substrates 210 and 310 may be produced by using polyethylene terephthalate (PET), polycarbonate (PC), polyethersulfone (PES), polyetherketone (PEEK), polyethylene naphthalate (PEN), polyimide (PI), or the like.

In the display device 100 shown in FIG. 1C, the plurality of signal line driving elements (first driving elements) 260 and scanning line driving elements (second driving elements) 270 are preferably mounted on the first insulative substrate 210; however, the present invention is not limited thereto. There may be one signal line driving element (first driving element) 260 and one scanning line driving element (second driving element) 270.

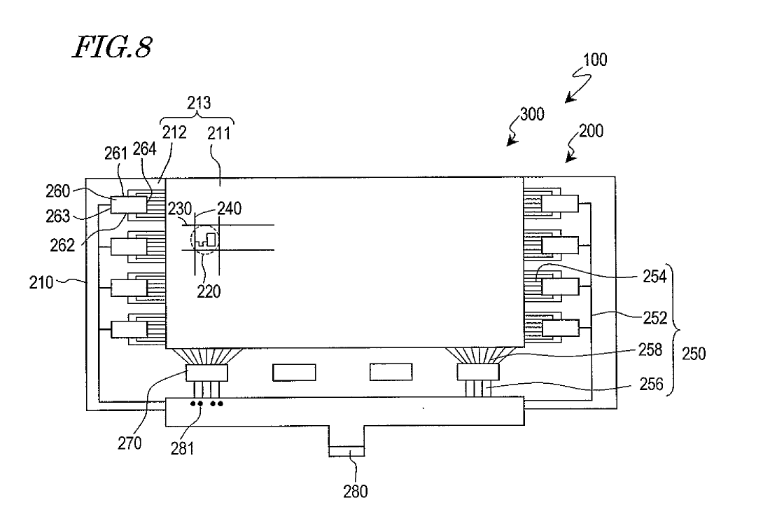

In the above description, the first driving elements each having a longer side extending parallel or substantially parallel to the first lines are signal line driving elements; however, the present invention is not limited thereto. The first driving elements may be scanning line driving elements. In this case, as shown in FIG. 8, the first lines 230 are scanning lines; the second lines 240 are signal lines; the first driving elements 260 are scanning line driving elements; and the second driving elements 270 are signal line driving elements. As shown in FIG. 8, the scanning line driving elements 260 may be laterally positioned so that the longer sides 261, 262 of each scanning line driving element 260 are parallel or substantially parallel to the direction in which the scanning lines 230 extend, thus allowing the first insulative substrate 210 and the second insulative substrate 310 to be curved along the vertical direction. Thus, both of the scanning line driving elements 260 and the signal line driving elements 270 are unlikely to be detached from the first insulative substrate 210, whereby the electrical connection of the scanning line driving elements 260 and the signal line driving elements 270 is ensured. Moreover, the first output substrate lines 254 being connected to the scanning line driving elements 260 are provided closer to the displaying region than are the first input substrate lines 252. As a result, the first input substrate lines 252 and first output substrate lines 254 connected to one scanning line driving elements 260 can be formed within a narrow region.

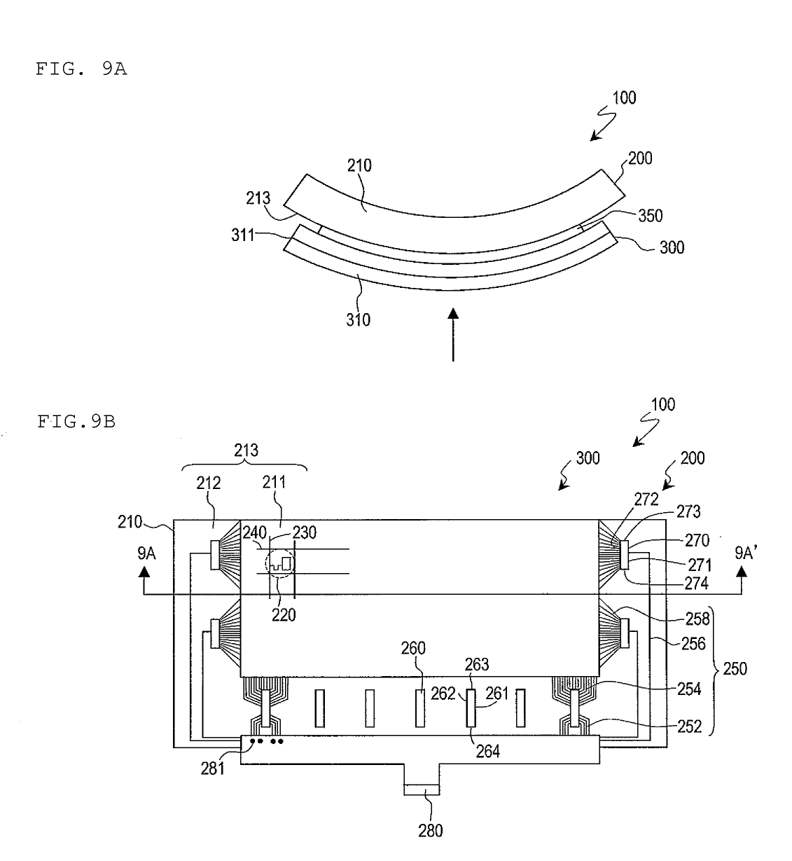

In the above description, the display surface is preferably curved in a concave shape toward the viewer; however, the present invention is not limited thereto. As shown in FIG. 9A, the display surface may be curved in a convex shape toward the viewer. In this case, as shown in FIG. 9A, the principal surface 213 of the first insulative substrate 210 is curved in a convex shape; the principal surface 311 of the first insulative substrate 310 is curved in a concave shape; and as shown in FIG. 9B, the signal line driving elements 270 are vertically positioned. Note that FIG. 9A corresponds to a cross section along line 9A-9A′ in FIG. 9B.

In the above description, the display device preferably is a liquid crystal display device; however, the present invention is not limited thereto. The display device may be any arbitrary display device, such as an organic EL display device, a plasma display device, or an SED display device. In the case where the display device is an organic EL display device, the display device does not need to include a counter substrate, but a display medium layer (i.e., an organic EL layer) may be disposed on a principal surface of an active matrix substrate.

According to various preferred embodiments of the present invention, there is provided a display device in which detachment of driving elements from a curved insulative substrate is prevented, and in which an increase in size of the insulative substrate is reduced. Moreover, according to various preferred embodiments of the present invention, a display device which is suitably used for an instrument panel can be provided. This instrument panel is suitably used for various types of automotive vehicles, e.g., a car, a motorbike, a bus, a truck, a tractor, an airplane, a motor boat, a vehicle for civil engineering use, a train, or the like. Moreover, according to various preferred embodiments of the present invention, a display device which is capable of displaying a realistic video can be provided.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-13. (canceled)

14: A display device comprising:
an active matrix substrate; and
a display medium layer disposed on a principal surface of the active matrix substrate; wherein
the active matrix substrate includes:
an insulative substrate having a principal surface which includes a displaying region and a terminal region;
a plurality of circuit elements provided in the displaying region of the insulative substrate;
a plurality of first lines and a plurality of second lines connected to the plurality of circuit elements;
a plurality of substrate lines provided in the terminal region of the insulative substrate;
at least one first driving element mounted in the terminal region of the insulative substrate and arranged to supply a signal to the plurality of first lines; and
at least one second driving element mounted in the terminal region of the insulative substrate and arranged to supply a signal to the plurality of second lines;
the insulative substrate is curved;
the plurality of substrate lines include a plurality of first input substrate lines which are electrically connected to the at least one first driving element and a plurality of first output substrate lines which are electrically connected to the plurality of first lines and the at least one first driving element, the first output substrate lines corresponding to the at least one first driving element being disposed so as to be closer to the displaying region than are the first input substrate lines; and
when the at least one first driving element is viewed from a normal direction of the principal surface of the insulative substrate, the at least one first driving element has a rectangular or substantially rectangular shape with two longer sides and two shorter sides, the at least one first driving element being mounted so that each longer side thereof is parallel or substantially parallel to a direction in which the first lines extend.

15: The display device of claim 14, wherein input bumps electrically connected to the first input substrate lines and output bumps electrically connected to the first output substrate lines are provided on the at least one first driving element.

16: The display device of claim 14, wherein, when the at least one second driving element is viewed from the normal direction of the principal surface of the insulative substrate, the at least one second driving element has a rectangular or substantially rectangular shape with two longer sides and two shorter sides, the longer sides of the at least one second driving element being disposed parallel or substantially parallel to the longer sides of the at least one first driving element.

17: The display device of claim 14, wherein the insulative substrate is curved in a direction which is perpendicular or substantially perpendicular to each longer side of the at least one first driving element.

18: The display device of claim 14, wherein the principal surface of the insulative substrate is curved in a concave shape.

19: The display device of claim 14, wherein the principal surface of the insulative substrate is curved in a convex shape.

20: The display device of claim 14, wherein each first line is one of a signal line and a scanning line, and each second line is the other of a signal line and a scanning line.

21: The display device of claim 14, wherein the insulative substrate is a glass substrate.

22: The display device of claim 14, wherein the insulative substrate is a plastic substrate.

23: The display device of claim 14, wherein the at least one first driving element and the at least one second driving element are each mounted via an anisotropic electrically-conductive layer.

24: The display device of claim 14, further comprising a counter substrate opposing the active matrix substrate via the display medium layer, wherein the display medium layer is a liquid crystal layer.

25: The display device of claim 14, further comprising a circuit arranged to receive a television broadcast.

26: An automotive vehicle comprising the display device of claim 14 which defines at least a portion of an instrument panel.
